(19) United States
(12) Patent Application Publication
(10) Pub. No.: US 2010/0170836 A1
(43) Pub. Date: Jul. 8, 2010

(54) Wastewater Vent Gas Adsorption Filter

(76) Inventors: Louis John Pagano, West Milford, NJ (US); Mark Steven Russo, Northvale, NJ (US); Anthony J. Prisco, JR., Cinnaminson, NJ (US)

Correspondence Address: Louis Pagano, 6 Jacobs Road, West Milford, NJ, 07480, US

(21) Appl. No.: 12/348,296

(22) Filed: Jan. 4, 2009

(51) Int. Cl. B01D 35/01

(52) U.S. Cl. 210/151

(57) ABSTRACT

The objective of the unit 10 is mainly to adsorb Hydrogen Sulfide gas (also known as H2S) and other gases including but not limited to Carbon Dioxide 26 from plumbing, sewer, and wastewater management system vents 21 thereby removing the odor and or greenhouse gasses associated with the air stream/gas 26. The unique “T” 12 shape design along with the unique disc containment system 14 holds the filtration media 16 in the horizontal portion of the “T” 12a. configuration allows fresh air 28 to blend with the odorous gasses 26 passing through the filter media 16 within the containment chamber and reduces their concentration (PPM) thereby increasing the life of the unit 10. Having the inlet to the filtration media at the base of the vertical portion of the “T” 12a and two outlets of equal size diameter or greater also reduces Pressure drop across the media 16. The disc containment system 14 eliminates the need for a Media bag or cartridge reducing maintenance costs.

An air adsorber or filter also called an air scrubber or a Bio Filter that mounts inline or atop building structure sewer system, Boat waste water vents or waste water management lift station/sewer line vents which is designed to adsorb escaping gasses thereby removing any odors and greenhouse gases that are emitted from those gasses including but not limited to Hydrogen Sulfide, Carbon Dioxide, and Methane. The unique “T” shape design allows fresh air to blend with the odorous gasses passing through the filter media within the containment chamber which reduces their concentration (Parts Per Million or PPM) thereby greatly increasing the life of the unit

For the purpose of promoting and understanding of the invention numbered references will be made to the invention illustrated in the drawings. Item 10 in the drawings is the overall invention.

Housing—2 types. 12 and 12A Serves as the main body of the unit 10. The preferred material for construction of the inventions housing 10 is schedule 40 PVC (Poly Vinyl Chloride). However, any other form of Plastic, Plastic composite, Resin, Resin composite metal or metal alloy may be utilized in any combination to create the housing 10. Containing the filter media 16. The “T” shape design 12 acts as a built in rain cap to prevent rainwater from entering the plumbing vent system 21. It is unique as it also allows cross through ventilation to wick away moisture that typically builds up around plumbing vent openings 21 and helps prevent what is known as “frost horing”. The “T” shape 12 with cross flow ventilation also allows fresh air 28 to be blended with the odorous/greenhouse gasses 26 thus diluting the quantity (PPM) of odorous/greenhouse gasses 26 exposed to the filtration media 16. This blending of fresh air and odorous air 26a increases the life expectancy of the media 16 and enables a smaller quantity of media 16 to perform at levels where a larger quantity would normally be required. This makes for a lower profile unit 10 and reduces operating costs. 2) Cylindrical shape-used in the “inline” design 12a. It is unique as it allows the use of vent pipe odor absorbers in those applications where a vent top unit is not feasible.

Perforated Discs 14—Are preferably made of ⅛ inch thick gray PVC sheet stock with 3/32 inch holes spaced every 5/32 of an inch. However The discs 14 may be manufactured from any form of plastic, Plastic composite, Resin, Resin composite metal, metal alloy or any combination thereof and the spacing and size of the perforated holes may vary to accommodate various forms of media 16 and air flow. Each disc 14 is cut to a round shape of varied size to accommodate the opening of the different sized filter housings 12,12a however the shape of the disc can vary to accommodate any shape needed to fit the filter housing openings 12,12a. These discs are ultra sonic welded, thermal welded, chemically boded, press fit or can be molded as a single unit with the main filter housing as needed into each opening of the housing 12,12a (3 each are used in the “T” 12 design and 2 each are used in the cylindrical, inline design 12a. The perforated discs 14 may also be an integral part of the housing 12,12a mold eliminating the need to cut and install the discs 14. The discs 14 help contain the filter media 16 within the housing 12,12a and the perforations allow the vent gasses 26 to pass through the housing 12,12a (top to bottom), over the contained media bed 16. In the case of the “T” 12 design, the discs 14 also allow fresh air 28 to circulate through the housing 12 (side to side) to wick away moisture, dilute the odorous gas 26 reducing the concentration (PPM) and carry away the scrubbed gasses 30.

Media Bed 16 Can be a variety of adsorptive materials but is mainly an activated carbon specifically developed to adsorb odorous gasses 26. For removing greenhouse gasses, the activated carbon will typically be blended with an additional media 16. The adsorptive media 16 can be a variety of materials but is mainly a granular combination of magnesium oxide, Titanium (IV) Dioxide, and Zinc Oxide. The Activated Carbon or other media 16 can also be impregnated with a variety of chemicals to perform both functions of removing odorous gasses and greenhouse gasses.

Gasses 26 that normally vent through the vent pipe 21 and into the atmosphere pass through either the inline 12a or top mounted “T” 12 shape unit, through the perforated disc 14 on the inlet side of the adsorber (filter) unit 12, then pass through the media bed 16 (typically activated carbon) where the odorous gas 26 is adsorbed 26b thus removing any odors associated with the gas. Further, in the “T” 12a shaped design, fresh air 28 passes from side to side through the perforated discs 14 on the “outlet” sides, diluting 30 the odorous gasses 26 Reducing there PPM and also wicking away any moisture build up and carrying away the scrubbed gas 26b.

The unit 10 can (and should) be structured in an “in-line”12a fashion so as to be placed “in-line” of the plumbing vent 21 system rather than just atop the vent 21. The perforated disk 14 containment system allows greater flexibility in use for many different plumbing vent designs and applications. It can (and is) built in different sizes to accommodate the many sizes of plumbing vent pipes 21 and volumes of escaping odorous gases 26 from plumbing vent systems. The unit 10 can be utilized for air filtration systems other than plumbing and wastewater applications.

The unit 10 can be filled with many different types of activated carbon or other adsorbing media 16 that is designed to remove specific types of gases other than Hydrogen Sulfide.

### DRAWING DESCRIPTION

FIG. 1 is a perspective view of the invention 10 shown in use.

FIG. 2 is a cross section view of the invention 10 taken along lines 2-2 of FIG. 1.

FIG. 3 is a perspective view of an alternate embodiment of invention 10 shown in use.

FIG. 4 is a cross section view of the alternate embodiment of invention 10 taken along lines 4-4 of FIG. 3.

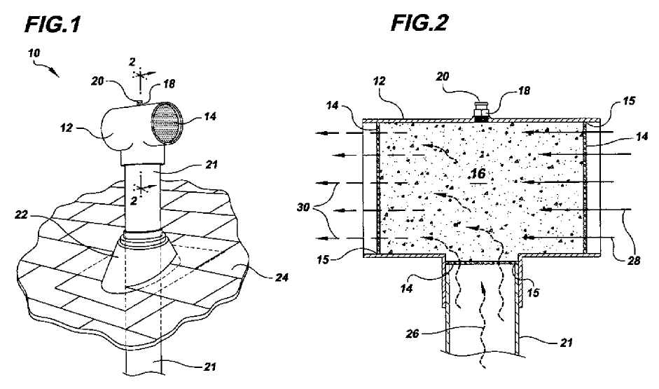

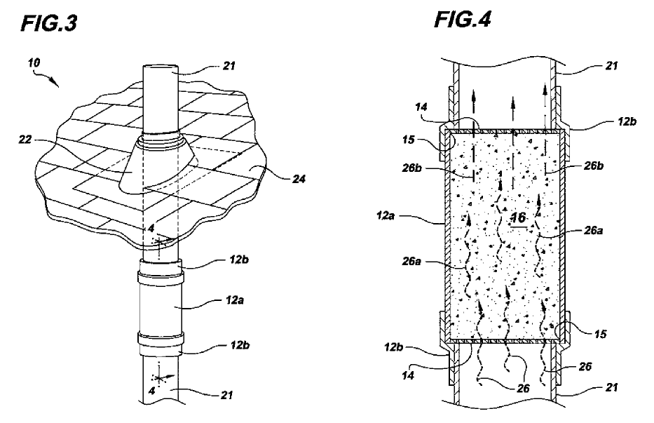

### DESCRIPTION LIST

10: is the overall invention of an air adsorber or filter also called an air scrubber or bio filter that mounts atop or inline a sewer system, septic system, or plumbing system vent and greatly reduces odorous gasses and greenhouse gases that exit the vent. The main objective of the invention 10 is to adsorb Hydrogen Sulfide gas also known as H2S and other gases including but not limited to Carbon Dioxide and Methane from plumbing, sewer, and wastewater vents. The “T” shaped design allows fresh air to pass through the filter media 16 and blends with gasses to reduce their concentration (parts per million or PPM) thereby greatly increasing the life of the unit. The “T” shaped unit also acts as a rain cap and with its fresh airflow helps to control moisture in cold climates and it aids in natural regeneration of the filtration media 16. There are two options of the invention 1) is a typical inline venting system which is installed inline on the vent and contains the filter media 16 within the main body 12a by two perforated discs 14 one at the top and one at the bottom of the inline filter. 2) is a “T” design which allows for fresh air 28 to pass through and mix with the filter media 16 and the venting gasses 26. The filter media 16 is held in place by 3 perforated discs 14 one at each end of the “T” and one at the inlet of the “T”. This design acts as a rain cap and also helps dissipate moisture buildup in cold climates. 12:

12: is the rooftop containment system made from a typical PVC “T” (sized to fit vent pipe).

12a: is the main body of the inline containment system made from a section of PVC pipe (sized to fit vent pipe) and two couplings 12b also sized to fit vent pipe.

12b: are the upper and lower couplings of the inline containment system made from typical PVC couplings (sized to fit vent pipe).

14: is the perforated discs used to contain the filter media 16 within the containment system, these perforated discs 14 are typically made from ⅛″ PVC sheet stock with 3/32″ holes spaced every 5/32″ and are cut to a round shape to accommodate the opening of the containment filters and the discs 14 are welded, bonded or molded into place 15.

15: is the method of attaching the perforated discs 14 to the containment filters 12, 12a, through means of ultra sonic welding, thermal welding, chemical bonding, press fit, molding or other suitable means.

16: is the filter media which can be made from different types of activated carbon or any suitable media to reduce odors and greenhouse gases.

18: is a typical drain plug.

20: is a saturation indicator which will notify the owner when the filter media 16 is nearing it life end.

21: is a typical building vent pipe.

22: is a weather boot for pipes passing through a buildings roof.

24: is typical roofing material

26: are gasses from plumbing, sewer, and wastewater vents.

26a: are gasses from plumbing, sewer and wastewater vents that have completely passed through the filter media 16 and became filtered.

28: is fresh air

30: is a combination of fresh air and filtered gasses from plumbing, sewer and wastewater vents.

While the present invention has been described in terms of specific embodiments, it is to be understood that the invention is not limited to these disclosed embodiments. This invention may be embodied in many different forms and should not be construed as limited to the embodiments set forth herein; rather, these embodiments are provided by way of illustration only and so that this disclosure will be thorough, complete and will fully convey the full scope of the invention to those skilled in the art. Indeed, many modifications and other embodiments of the invention will come to mind of those skilled in the art to which this invention pertains, and which are intended to be and are covered by both this disclosure, the drawings and the claims.”

What is claimed is:

1. The unit 10 achieves its objective by utilizing a “T” 12 shaped design with the inlet at the bottom of the vertical portion of the unit 10. The filtration Media_16 is contained in the horizontal portion of the “T” 12 with our perforated disc 14 containment system. Each end of the Horizontal portion of the “T” 12 is exposed to outside air 28. Containment of the Media 16 in this way allows fresh air 28 to encircle the Media 16 and blend with the odorous gasses 26 reducing the odorous gasses PPM thus increasing the odor control capabilities of the filtration media 16 and increasing the medias overall life expectancy. The fresh airflow 28 through design of the unit 10 allows Moisture normally contained in vent system 21 to be wicked away from the media 16 eliminating a common vent problem in cold climates called Hore Frosting. Wicking away of the moisture also aids in a natural regeneration of the filtration media 16.
